(19) United States
(12) Patent Application Publication
(10) Pub. No.: US 2002/0100827 A1
(43) Pub. Date: Aug. 1, 2002

(54) Paper shredder

(76) Inventor: Ming-Hui Ho, Hsin Chuang City (TW)

Correspondence Address: Keith Kline, PRO-TECHTOR INTERNATIONAL SERVICES, 20775 Norada Court, Saratoga, CA, 95070-3018, US

(21) Appl. No.: 09/774,744

(22) Filed: Jan. 30, 2001

(51) Int. Cl. B02C 18/18

(52) U.S. Cl. 241/100; 241/236

(57) ABSTRACT

A paper shredder has two rotary cutters driven by a decelerating device and a casing encased the two rotary cutters and the decelerating device and having a guiding track defined between the two rotary cutters to allow the stuck paper to be directed directly into the can mounted below the two rotary cutters without damaging any mechanism.

### BACKGROUND OF THE INVENTION

1. Field of the Invention

The present invention relates to a paper shredder, and more particularly to a paper shredder having guiding slots defined between a first and a second paper pushes on two rotary cutters and a casing so as to eliminate the blockage by the shredded paper. Furthermore, the casing encased the motor, the decelerating mechanism to prevent the shredded paper from falling into the motor or the decelerating mechanism and thus casing malfunction.

2. Related Prior Art

A conventional paper shredder, when operated, will automatically have the shredded paper fallen into the trash can. However, having the shredded paper fallen into the trash can, the motor of the paper shredder needs to rotate in a reversed direction so as to allow the shredded paper to escape from the rotary cutters to smoothly fall into the trash can, which allows a small amount of shredded paper stuck in the shredder. When the amount of shredded paper increases, the paper shredder will not function normally. Thus a user will have to disassemble the paper shredder to clean the shredded paper to resume the function of the paper shredder. Furthermore, the rotary cutters of the conventional paper shredder are exposed directly to the outside of the shredder, which not only affects the overall appearance, but also easily causes malfunction to the mechanism due to the fallen dust and objects.

The present invention provides an improved paper shredder to overcome the above mentioned shortcomings.

### SUMMARY OF THE INVENTION

The primary objective of the invention is to provide an improved paper shredder to allow the shredded paper to fall into the trash can directly without blockage the function of the mechanism.

Another objective of the invention is to provide a blocking device in the entry of the paper shredder to prevent any undesired objects from falling into the paper shredder to malfunction any mechanism in the machine.

Still another objective of the invention is to provide an improved paper shredder having a first and a second paper pushes on the two rotary cutters of the paper shredder so as to guide the shredded paper easily.

Still another objective of the invention is that each of the first and the second paper pushes have an identification hole, such that the user is able to quickly and easily assemble the rotary cutters on the paper shredder.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the paper shredder constructed in accordance with the present invention;

FIG. 2 is a top plan view of the paper shredder of FIG. 1 with the top cover removed;

FIG. 3 is a front plan view of the paper shredder of FIG. 2;

FIG. 4 is a schematic side view of the paper shredder of the invention;

FIG. 5 is a partial enlarged schematic view showing the mounting of a blocking device mounted on top of two rotary cutters of the invention;

FIG. 6 is a perspective view of the rotary cutters of the present invention;

FIG. 7 is a cross sectional view of the paper pushes mounted on the axle; and

FIG. 8 is a cross sectional view of the paper pushes together with the pads of the present invention.

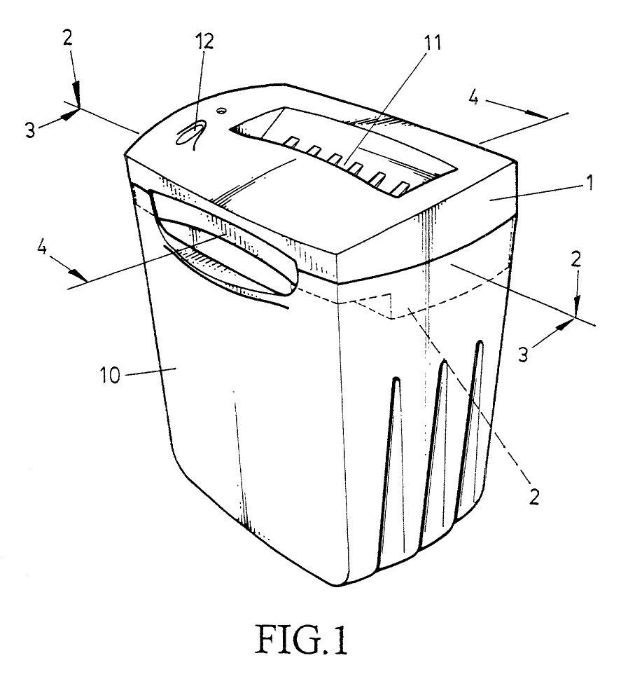

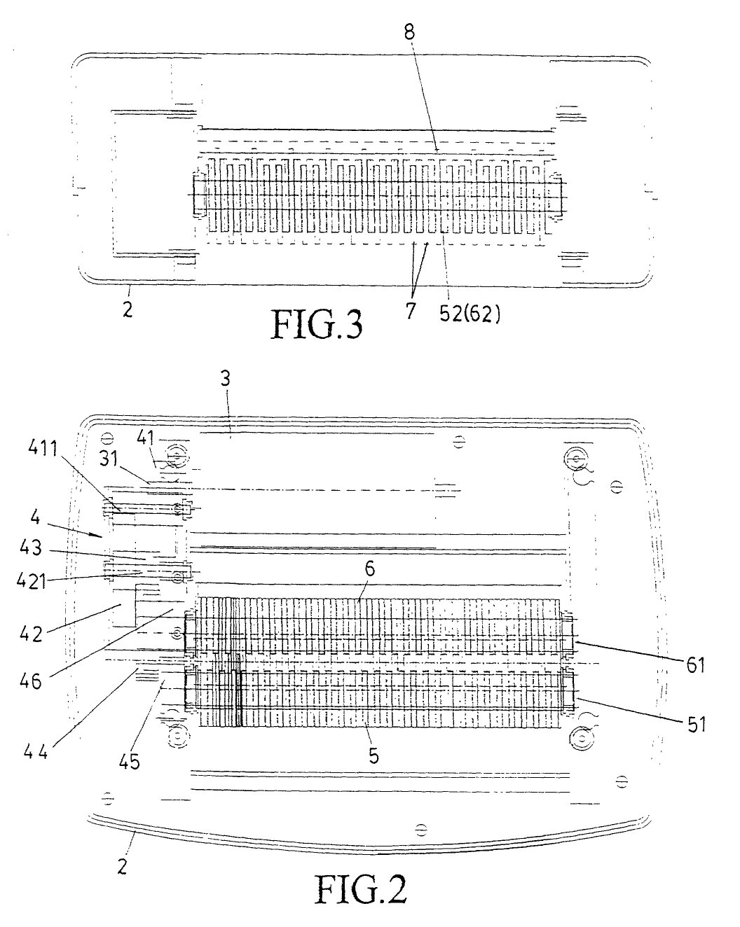

### DETAILED DESCRIPTION TO THE PREFERRED EMBODIMENT

With reference to the figures, a paper shredder of the invention has a top cover 1, a base 2 and a can 10.

The top cover 1 has an entrance 11 defined to allow the entrance of waste paper and a switch 12 mounted to connect with circuits (not shown) to control the operation of the paper shredder.

The base 2 is provided to securely accommodate a motor 3, a decelerating device 4, two rotary cutters 5, 6 and two paper pushes 7, 8.

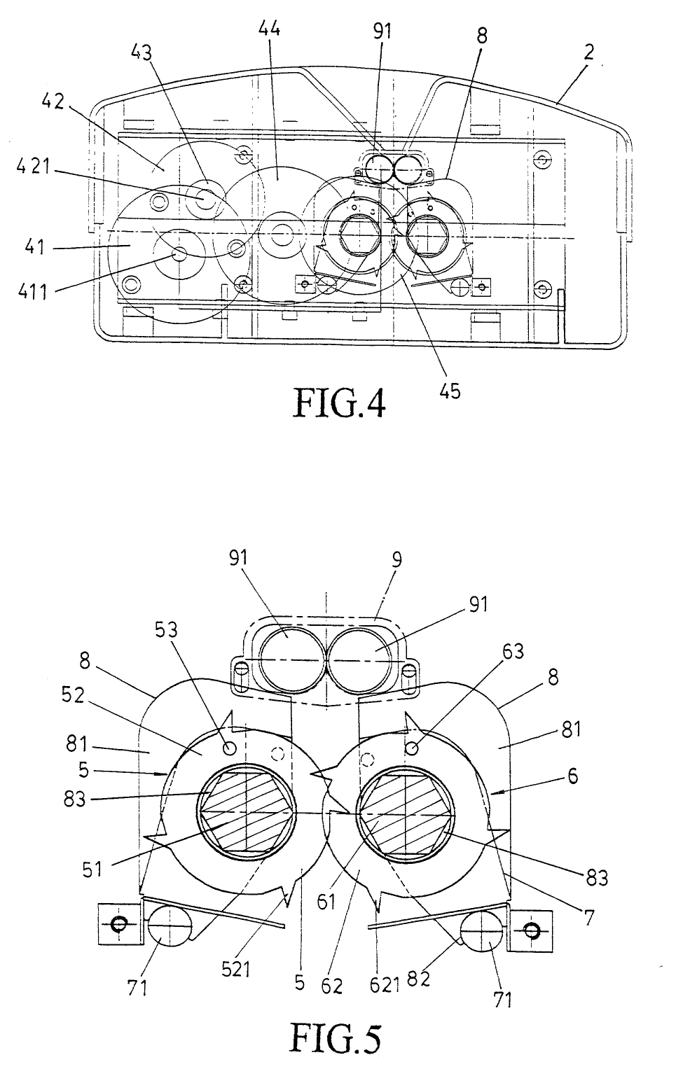

The motor 3 is connected with the switch 12 by means of wires such that the switch 12 is able to control the operation of the motor 3. The motor 3 drives the motion of the decelerating device 4. In the preferred embodiment of the invention as shown in FIGS. 3 and 4, the shaft 31 of the motor 3 is mated with the shaft 41 of the first gear 41 and the shaft 411 of the first gear 41 is mated with a second gear 42. The shaft 421 of the second gear 42 is mated with a small gear 43 and the small gear 43 is mated with a big gear 44. The big gear 44 is then mated with two gears 45, 46. The two gears 45, 46 are respectively engaged with shafts 51, 61 of two rotary cutters 5, 6. In this arrangement, the two rotary cutters 5, 6 each have a first and a second blades 52,62 alternately mounted with each other and are driven to rotate by the decelerating device 4. The two paper pushes 7, 8 extend out from each of the first and the second blades 52,62. Each of the paper pushes 7,8 correlates with each other in such a manner that when the paper is shredded, both paper pushes 7,8 will help to push the shredded paper to a desired direction.

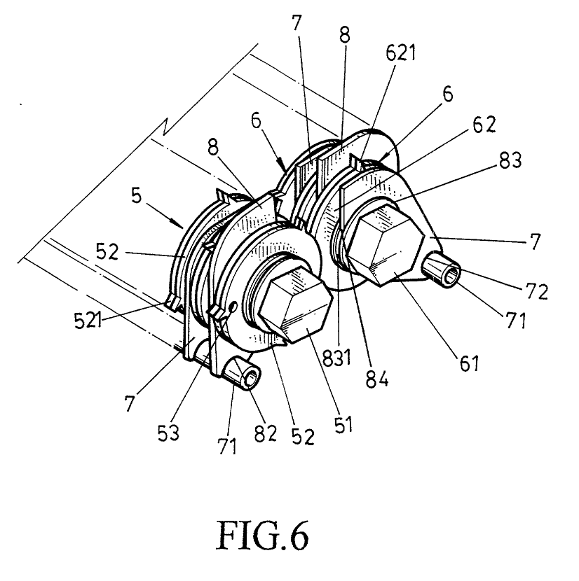

With reference to FIGS. 5 and 6, each of the two rotary cutters 5, 6 consists of two secondary cutters 52,62 and every secondary cutter 52,62 has multiple cutting edges 521,621. A guiding track 81 is then defined between the two paper pushes 7, 8, such that when the volume of the paper to be shredded is too large and the rotary cutters 5, 6 are stuck, a reverse rotation of the rotary cutters 5, 6 will drive the jammed paper into the guiding track 81. The jammed paper will then still fall into the can 10. Furthermore, the second paper push 8 isolates the rotary cutters 5, 6 from the decelerating device 4 and the motor 3 so as to avoid malfunction caused by the jammed paper when being driven by the reverse rotation of the rotary cutters 5, 6.

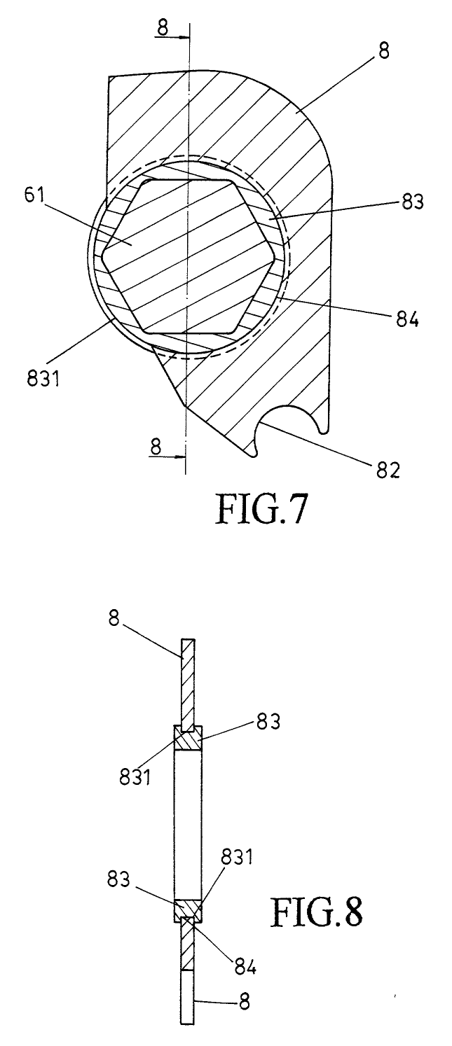

Referring again to FIGS. 4, 5 and 6, a tube 71 is respectively mounted under the two rotary cutters 5, 6, such that notches 72, 82 of each of the paper pushes 7, 8 mate with the tube 71 and the paper pushes 7, 8 are then secured. A washer 83 is respectively secured on the shafts 51,61 of the two rotary cutters 5,6 and has a cutout 831 defined to correspond to an edge 84 of the paper push 8, as shown in FIGS. 7 and 8.

It is to be noted that a seat 9 is mounted on top of the casing 8 and having two cylinders 91 closely engaged with each other. The joint between the two cylinders 91 corresponds to the entrance 11 of the top cover 1. The two cylinders 91 are spring-biased such that when a paper is to be shredded, the user inserts the paper into the entrance 11 and the paper will slit through the joint of the two cylinders 91. With the provision of the two cylinders 91, dust and alien objects are prevented to fall into the mechanism to cause any damage.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A paper shredder comprising:
a top cover having an entrance defined to allow the entrance of waste paper and a switch mounted to control the operation of the paper shredder;
a base provided to engage with the top cover;
a motor electrically connected with the switch to drive the motion of a decelerating device;. two rotary cutters substantially and mutually engaged with each other and each having multiple integrally formed blades correlated with each other and two paper pushes respectively extending out therefrom for directing the paper to a desired direction;
a casing encasing the rotary cutters, the motor and the decelerating device and having a guiding track defined between the rotary cutters; and
a can mounted below the top cover to receive shredded paper;
whereby the rotary cutters are driven by the decelerating device and the entrance of the top cover corresponds to the joint between the two rotary cutters.

2. The paper shredder as claimed in claim 1, wherein a seat is mounted on top of the casing and having two spring-biased cylinders closely engaged with each other and the joint between the two cylinders corresponds to the entrance of the top cover.

3. The paper shredder as claimed in claim 1, wherein each of the rotary cutter consists of two secondary cutters and each of the secondary cutter has a identification hole for easy identification.

4. The paper shredder as claimed in claim 2, wherein each of the rotary cutter consists of two secondary cutters and each of the secondary cutter has a identification hole for easy identification.

5. The paper shredder as claimed in claim 1, a washer is provided to a shaft of each of the two rotary cutters and as a cutout defined to correspond to an edge of each of the two paper pushes.

6. The paper shredder as claimed in claim 2, a washer is provided to a shaft of each of the two rotary cutters and as a cutout defined to correspond to an edge of each of the two paper pushes.

7. The paper shredder as claimed in claim 3, a washer is provided to a shaft of each of the two rotary cutters and as a cutout defined to correspond to an edge of each of the two paper pushes.

8. The paper shredder as claimed in claim 4, a washer is provided to a shaft of each of the two rotary cutters and as a cutout defined to correspond to an edge of each of the two paper pushes.
